(19) United States
(12) Patent Application Publication
(10) Pub. No.: US 2018/0018947 A1
(43) Pub. Date: Jan. 18, 2018

(54) ACOUSTIC STRING INSTRUMENT

(71) Applicant: Michael Miltimore, Kamloops (CA)

(72) Inventor: Michael Miltimore, Kamloops (CA)

(21) Appl. No.: 15/696,099

(22) Filed: Sep. 5, 2017

Related U.S. Application Data
(63) Continuation-in-part of application No. 14/118,137, filed on Feb. 11, 2014, now abandoned.
Application No. 14/118,137 is a continuation-in-part of application No. 13/107,940, filed on May 15, 2011, now abandoned.

(51) Int. Cl. G10D 3/04; G10D 3/06; G10D 1/08; G10D 3/12

(52) U.S. Cl. CPC G10D 3/04; G10D 3/06; G10D 1/08; G10D 3/12

(57) ABSTRACT

A musical instrument of the chordophone family is provided that has reduced stresses and strains, and is easily assembled. An adjustable strut allows for adjusting intonation and action in the strung instrument. The strut has course and fine adjusters that allow the strut to be moved up and down and in and out. As the strut is attached to the neck, this adjust string height and intonation. Further, the neck is independently adjustable. It can be moved from side to side to adjust string pull to be normal to the bridge, and in and out to adjust intonation. A method of constructing the instrument is also provided.

### CROSS-REFERENCE TO RELATED APPLICATIONS

This application is a continuation-in-part of U.S. patent application Ser. No. 14/118,137, filed Feb. 11, 2014, which is incorporated herein by reference in its entirety

### FIELD

The present technology is directed to a string instrument in which the stresses and strains on the soundboard are reduced, the instrument is more resonant, and the soundbox can be made of a wider range of materials, including woods that would not normally be considered to be strong enough for a soundbox, all through the implementation of a strut and neck combination. More specifically, the present technology is directed to a guitar having a floating neck and strut combination and a soundbox that can vibrate independently from the neck.

### BACKGROUND

Acoustic string instruments are subjected to high stresses and strains caused by the strings. As the instrument is tuned, the strings are tightened, leading to force developing between the neck and the soundbox. The direct recipient of the force is the bridge. The force is then indirectly exerted on the soundboard. This may lead to damage to both the bridge and the soundboard. In extreme cases, the neck can also be affected by damaging the joint between the neck and the soundbox of the instrument. There are many designs that have been developed to reduce the stresses and strains. Most result in a rigid structure, which, while addressing the issue, do not necessarily result in an instrument that has improved sound quality.

The inner surfaces of the soundboard and back of guitars are provided with bracing to counteract the force. A complex pattern of bracing is used on the inner surface of the back. During construction of the instrument, a luthier spends a significant amount of time shaping the bracing in order to tune the instrument. In order to reduce the work, Griffiths (U.S. Pat. No. 6,333,454) provides a bracing system that combines kerfing, binding and bracing. One unit is for use with the soundboard and a second unit is for use with the back.

In U.S. Pat. No. 7,462,767, a bracing system is used to counter balance the force by using an additional string or cable, preferably made of Kevlar, carbon fiber or a similar non-elastic material that is attached to the bridge and the neck of the guitar within the soundbox. A bracket is located inside the soundbox of the instrument and attached to the bottom of the bridge of the instrument. It is connected to an adjustable brace by a non-elastic string. The adjustable brace may adjust the tension placed upon the string to control the amount of counter-balancing tension. This system does not alleviate the force, but rather, simply counter balances the force.

Another cause of stress to the instrument arises because the strings are not aligned between the headstock and the bridge such that they are normal to the bridge. The strings therefore exert a twisting force on the bridge and soundbox.

Despite the fact that many instruments are damaged by the two forces, those of the force on the bridge and soundboard and the force on the neck and the soundbox, the string instrument industry is reluctant to make change to reduce the forces exerted, preferring to retain the “look” of the instrument in preference to the health of the instrument.

Prior art guitars firmly attach the neck to the soundbox with bolts and glue and the neck block with bolts. While adjustments can be made during construction, once built, the positioning is fixed and rigid.

Steinberger et al., in U.S. Pat. No. 5,549,027 disclose a system to reduce the stresses of the strings on the guitar, as well as allowing for changing the action and intonation of the guitar. The neck, rather than terminating at the front of the guitar, extends through the body and is fastened to the tail block with a bolt. A shim is located between the tail block and the rear end of the neck. A bolt retains the neck at the heel block in a hole that is elongated along the long axis of the neck. The thickness of the shim can be varied and this causes the neck to pivot about the front of the body of the guitar at the heel block. This provides adjustment to the action of the guitar. Further, adjustment of the neck in a lengthwise direction can be effected by loosening the bolt the retains the neck at the heel block and the bolt that holds the neck at the tail block. This requires removing an access plate and loosening a removing a second bolt in the tail block. A change in the length of the neck will result in a change in the length of the strings, which results in intonation changes. Adjustments are made during construction of the guitar, before it is strung, or by removing the strings, removing the access plate, loosening the bolts and changing the shim. Once adjusted, the neck is held rigidly to the guitar body with the bolts. This design does not improve the sustain, the resonance and the volume. It would be difficult to adjust intonation once strung.

What needed is a guitar that is designed to better withstand the force exerted by the strings and provides superior sound qualities is. It would be advantageous if the design allowed the neck to float in the soundbox aperture and to vibrate freely from the soundbox. It would be of further advantage if the soundbox could be constructed of woods not normally considered to be strong enough. It would be of further advantage if the amount of bracing could be reduced, as doing so would impart superior sustain, resonance and volume. It would be of still further advantage if the design would allow for adjusting string pull so that it is normal to the bridge, to reduce torsional stress on the bridge and soundboard.

### SUMMARY

The present technology provides combinations for reducing the forces exerted by the strings on instruments in the chordophone family and provides superior sound qualities in the instruments. The design allows the neck to vibrate freely from the soundbox. The soundbox can be constructed of woods not normally considered to be strong enough, such as woods local to Canada, such as Red Cedar and other materials such as balsa wood or foam. The amount of bracing is reduced. This imparts superior sustain, resonance and volume. The design additionally allows for adjusting string pull so that it is normal to the bridge, thus reducing torsional stress on the bridge and soundboard.

In one embodiment, a chordophone instrument is provided, the chordophone instrument comprising: a soundbox, which defines an interior, the soundbox comprising sides with an upper edge and a lower edge, a back attached to the lower edge and a soundboard attached to the upper edge, the soundboard comprising a soundhole; an end block on an inner surface of the sides at a distal end of the instrument, the end block including a substantially vertically disposed slot; a bridge; a neck, the neck including a distal end and a proximal end, the neck in floating engagement with the soundbox; a strut, the strut extending from the end block to the distal end of the neck; an end bolt, the end bolt in threaded, adjustable engagement with a distal end of the strut and extending into the slot; a substantially vertically disposed fine adjustment screw, the fine adjustment screw abutting the end bolt, threadedly engaged in the end block, and extending through the back to an ambient environment; a headstock terminating the neck at the proximal end; at least one string extending between the headstock and the bridge; a neck block on an inner proximal surface of the sides; an intonation bolt, the intonation bolt in threaded engagement with the neck block and extending from the interior of the soundbox to the distal end of the neck, where it abuts the neck; and a neck positioner in threaded engagement with the neck block and in contact with the neck in a vicinity of the distal end.

In the instrument, the instrument may be a guitar.

In the instrument, the neck positioner may be either: a strap pin passing from the ambient environment through the neck, in an unthreaded oversized aperture, proximate the soundbox and in threaded engagement with the neck block; or a pair of intonation pins in threaded engagement with the neck block and abutting the distal end of the neck or vice versa.

In the instrument, the sides at the distal end of the instrument may include the substantially vertical slot and the end bolt extends through the slot to the ambient environment.

In the instrument, the neck positioner may be the strap pin.

In the instrument, the neck positioner may be the pair of intonation pins.

In the instrument, the neck block may define a balance point for the neck and the strut, with the weight being equally distributed between the strut and the neck.

In the instrument, the end bolt may be a flexible bolt.

In another embodiment, a method of constructing a chordophone instrument is provided, the chordophone instrument comprising: a soundbox, the soundbox comprising sides, a back and a soundboard, the soundboard comprising a soundhole; an end block on an inner distal surface of the sides, the end block including a vertically disposed slot; a bridge; either a neck and a strut, or neck and strut unit body, the neck including a distal end and a proximal end; an end bolt; a fine adjustment screw; a headstock terminating the neck at the proximal end; a neck block at a proximal end of the soundbox; an intonation bolt; and a pair of intonation pins attached to either the neck block or a distal end of the neck, the method comprising:

attaching the back of the soundbox and the soundboard to the sides of the soundbox to provide the soundbox with a soundbox aperture and an interior; connecting the strut to the neck at a neck distal end or employing the or neck and strut unit body;

introducing the strut and the neck so connected together into the soundbox through the

soundbox aperture and allowing it to float therein;

adjustably affixing the strut to the end bolt, adjustably locating the end bolt in the slot in the end block;

adjustably affixing the fine adjustment screw in the end block and butting it against the end bolt;

threadedly engaging the intonation pins to either the distal end of the neck or the neck block but not both;

either abutting the intonation pins that are attached to the distal end of the neck against the neck block proximally or abutting the intonation pins that are attached to the distal end of the neck against the neck block proximally;

threadedly engaging the intonation bolt to the neck block and abutting it against the distal end of the neck;

and stringing the instrument, to provide a strung instrument.

The method may further comprise adjusting the angle of the strings relative to the bridge by shifting the neck to one side or the other about the intonation pins.

The method may further comprise intonating the strung instrument by urging the neck to or away from the neck block with the intonation bolt.

The method may further comprise adjusting the neck angle of the strung instrument by moving the end bolt up or down in the vertically disposed slot.

In the method a vertically disposed fine adjustment screw may urge the end bolt up in the vertically disposed slot.

In another embodiment, a method of constructing a chordophone instrument is provided comprising: a soundbox, the soundbox comprising sides, a back and a soundboard, the soundboard comprising a soundhole; an end block, an end block on an inner distal surface of the sides, the end block and the side both including a distally located vertical slot; a bridge; either a neck and a strut, or neck and strut unit body, the neck including a distal end and a proximal end; an end bolt; a headstock terminating the neck at the proximal end; a neck block at a proximal end of the soundbox; a pair of intonation pins threadedly attached to either the neck block or a distal end of the neck, the method comprising: and

attaching the back of the soundbox and the soundboard to the sides of the soundbox to provide the soundbox with a soundbox aperture and an interior; connecting the strut to the neck at a neck distal end or employing the or neck and strut unit body;

introducing the strut and the neck so connected together into the soundbox through the soundbox aperture and allowing it to float therein;

adjustably affixing the strut to the end bolt, adjustably locating the end bolt in the slot in the end block and sides;

threadedly engaging the intonation pins to either the distal end of the neck or the neck block but not both;

either abutting the intonation pins that are attached to the distal end of the neck against the neck block proximally or abutting the intonation pins that are attached to the distal end of the neck against the neck block proximally;

and stringing the instrument, to provide a strung instrument.

The method may further comprise adjusting the angle of the strings relative to the bridge by adjusting the intonation pins in or out relative to one another.

The method may further comprise intonating the strung instrument by urging the neck to or away from the neck block with the end bolt and strut.

The method may further comprise adjusting the neck angle of the strung instrument by moving the end bolt up or down in the vertically disposed slot.

In another embodiment, a chordophone instrument is provided. the chordophone instrument comprising: a soundbox, which defines an interior, the soundbox comprising sides with an upper edge and a lower edge, a back attached to the lower edge and a soundboard attached to the upper edge, the soundboard comprising a soundhole; an end block on an inner distal surface of the sides, the end block and the sides including a substantially vertically disposed slot; a bridge; a neck, the neck including a distal end and a proximal end, the neck in floating engagement with the soundbox; a strut, the strut extending from the end block to the distal end of the neck; an end bolt, the end bolt in threaded, adjustable engagement with a distal end of the strut and extending into the slot; a headstock terminating the neck at the proximal end; at least one string extending between the headstock and the bridge; a neck block on an inner proximal surface of the sides; an intonation bolt, the intonation bolt in threaded engagement with the neck block and extending from the interior of the soundbox to the distal end of the neck, where it abuts the neck; and a pair of intonation pins either in threaded engagement with the neck block and abutting the neck at the distal end or vice versa.

In the instrument, the strut and neck are provided as a unit body.

The instrument may further comprise an intonation bolt, the intonation bolt in threaded engagement with the neck block and extending from the interior through the neck block and abutting the distal end of the neck.

A method of constructing a chordophone instrument with the above features is also provided.

### FIGURES

FIG. 1 is a perspective view of the guitar of the present technology.

FIG. 2 is a longitudinal section view of the guitar of FIG. 1.

FIG. 3A is an end view of embodiment 1 of the guitar of FIG. 1;

FIG. 3B is a longitudinal sectional view of the distal end of the guitar with the strut and end block;

FIG. 3C is a top sectional view of FIG. 3B, with the arrow showing flexing of the bolt and movement of the bolt and strut relative to the end block; and

FIG. 3D is a side sectional view of FIG. 3C showing flexing of the bolt and movement of the bolt and strut relative to the soundboard and back.

FIG. 4A is an end view of embodiment 2 of the guitar of FIG. 1;

FIG. 4B is a longitudinal sectional view of the distal end of the guitar with the strut and end block, with the adjustment screw removed to better show the aperture;

FIG. 4C is a top sectional view of FIG. 4B, with the arrow showing flexing of the bolt and movement of the bolt and strut relative to the end block; and

FIG. 4D is a side sectional view of FIG. 4C showing flexing of the bolt and movement of the bolt and strut relative to the soundboard and back.

FIG. 5 is an exploded longitudinal sectional view of embodiment A of the guitar of FIG. 1.

FIG. 6A shows the profile of the soundbox aperture and the distal end of the neck for all embodiments;

FIG. 6B shows the soundboard with the sound hole slot.

FIG. 7 is a longitudinal sectional view of embodiment B of the guitar of FIG. 1.

FIG. 8 is an exploded longitudinal sectional view of embodiment C of the guitar of FIG. 1.

### DETAILED DESCRIPTION

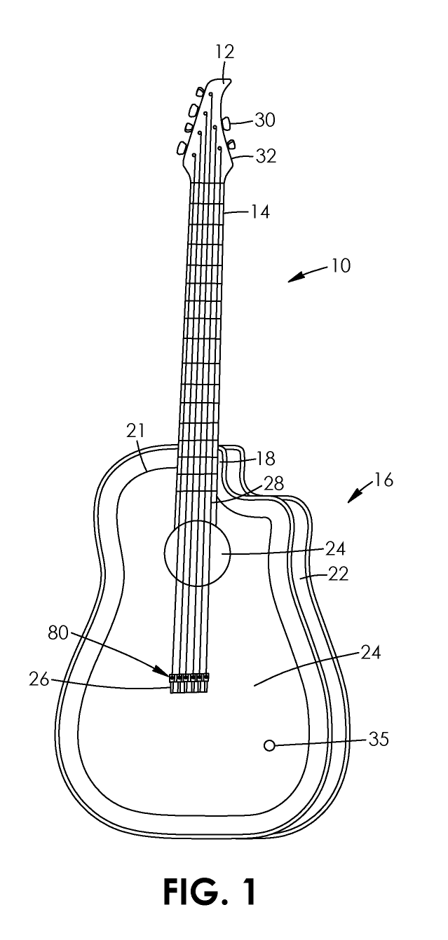

A guitar, generally referred to as 10 is shown in FIG. 1. The guitar has a headstock 12 and a neck 14 extending therefrom. The neck 14 enters the soundbox, generally referred to as 16 at a proximal end 18 of the soundbox 16. It is not attached to the soundbox 16 and can float freely in the soundbox aperture 200 of the soundbox 16. The soundbox 16 has a soundboard 20 forming the top of the soundbox 16 and sides 22. The soundboard 20 has a narrow, 2 mm deep groove around the periphery referred to as a “peripheral tone groove”21. The tone groove 21 allows the soundboard 20 to be more flexible. A sound hole 24 is located centrally in the soundboard 20. The headstock 12 is provided with tuning keys 30. A stationary voice coil with moving magnet 35 is provided to move the soundbox 16.

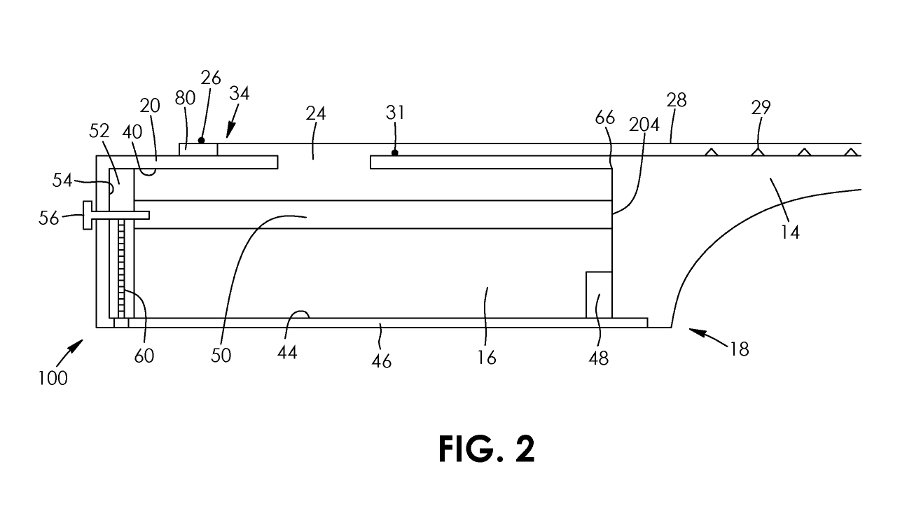

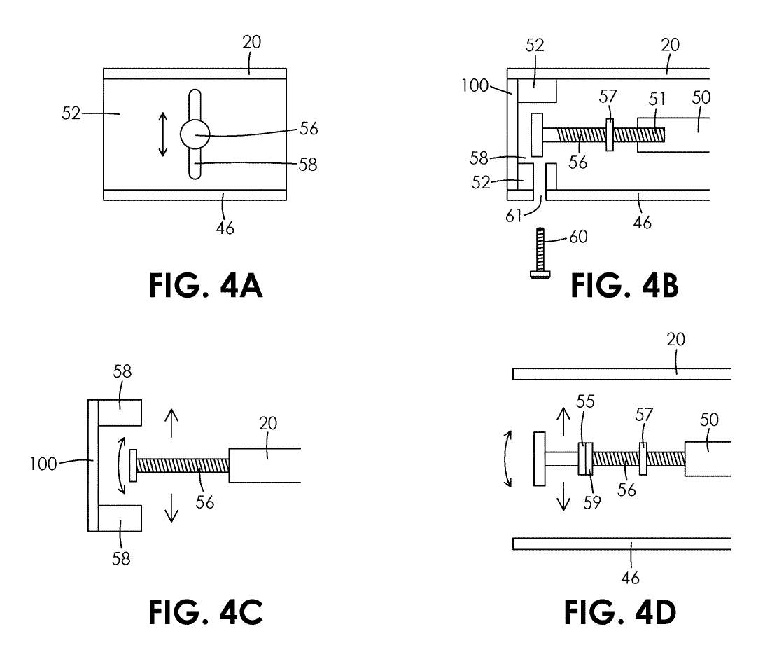

As shown in FIG. 2, it can be seen that the soundbox 16 is defined by the inner surface 40 of the soundboard 20, the inner surface 42 of the sides 22 (see FIG. 4) and the inner surface 44 of the back 46. The neck has an integral fretboard with frets 29. The strings 28 pass over the frets 29 and nuts 31 terminate at pins 26 that are engaged with the bridge 80. A strut 50 extends from the distal end 100 of the soundbox 16 to the distal end 66 of the neck 14. The junction of the strut 50 and the neck 14, which is at the soundbox aperture 200 (See FIGS. 4A-D and 6) is a pivot point 204. The pivot point 204 is also the balance point for the strut and neck combination, in other words, there is equal or nearly equal mass inside the guitar. This allows the neck to act as a tuning fork, having its own resonance. As the neck 14 floats in the soundbox aperture 200 it is able to function at its resonant frequency. Similarly, the neck 14 does not inhibit the sound box from resonating at its resonant frequency. The pivot point 204 allows the strut and body to flex. The string tension feels like there is a “spring” from the flex in the system and this translates into a more responsive instrument. The inner surfaces of the soundboard 20 and the back 46 have less bracing than would normally be required, and despite the reduced bracing, can be constructed of woods and other materials not usually considered to be strong enough for use in the soundbox 16. This is a result of the design of the strut and neck and their associated components (bolts, screws, pins). The reduction in bracing also allows the soundbox 16 to resonate more freely.

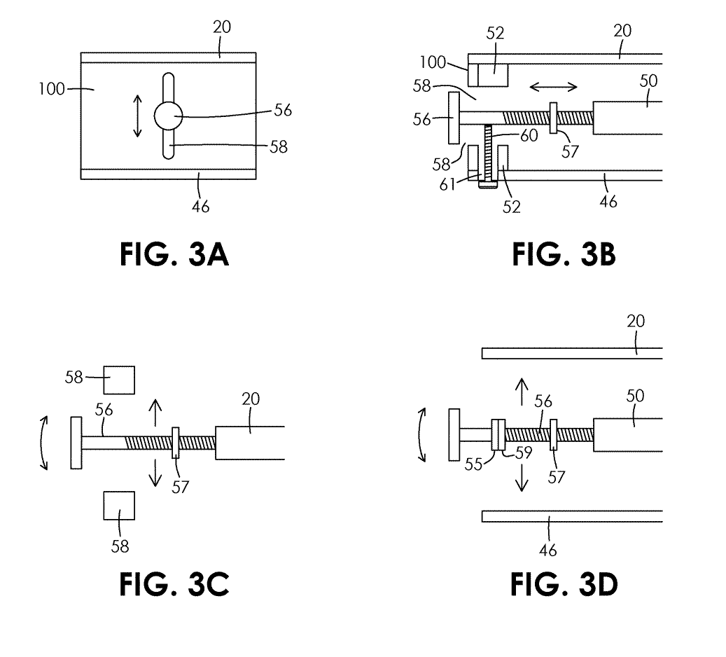

FIG. 2 also shows a strut 50 that abuts an end block 52 located on the distal inner surface 54, and is adjustably affixed by an end bolt 56. As shown in FIG. 3A, in embodiment 1, the end bolt 56 extends through a substantially vertical slot 58 (vertical in this context means that it extends a distance between the soundboard 20 and the back 46) in both the end block 52 and the side 22 at a distal end 100, extending into the ambient. The arrow shows how the placement of the end bolt 56 can be adjusted. As shown in FIG. 3B, the nut 57 on the end bolt 56 is locked in a given position along the length of the end bolt 56 between the end block 52 and the strut 50. Screwing the threaded end bolt 56 in or out of the end of the strut 50 causes the strut 50, which has a threaded aperture 51, to be drawn towards or away from the end block 52. This alters the absolute length of the strut 50 and end bolt 56 combination and pushes or pulls the neck 14 out or in relative to the soundbox 16. As shown in FIGS. 3C and 3D, the end bolt 56 and end bolt aperture 51 allow for some play and the end bolt 56 is also soft so it can flex. The flex under load means that the strut 50 is not firmly attached, so again, the neck 14 can vibrate. The end bolt 56 has a Teflon washer 55 and a metal washer 59 to allow it to slide up and down in the vertical slot 58. Returning to FIG. 3B, a fine adjustment screw 60 in the end block 52 is vertically disposed and abuts the end bolt 56. It extends through a threaded vertical aperture 61 in both the end block 52 and the back 46. The adjustment up and down alters the effective length of the strut 50, in other words, the distance between the distal end, generally referred to as 100 and the proximal end, generally referred to 18, of the soundbox 16 (as shown in FIG. 2). More significantly, the adjustment allows for adjustment of the height of the strings 28, by adjusting the neck angle. This is of further benefit because it doesn't change the break angle of the strings. When used with embodiment A, B or C, described below, movement of the strut 50 in or out or up or down urges the neck 14 in or out of the soundbox and up or down. Adjustment of the strut 50 and therefore the neck 14 can be done under string tension.

In another embodiment, embodiment 2, shown in FIG. 4A, the slot 58 is only in the end block 52 and not through the side 22 at the distal end 100. As shown in FIG. 4B, a nut 57 on the end bolt 56 is locked in a given position along the length of the end bolt 56 between the end block 52 and the strut 50. Thus, screwing the threaded end bolt 56 in or out of the end of the strut 50 causes the strut 50, which has a threaded aperture 51, to be drawn towards or away from the end block 52. This is done during construction of the guitar and is not changeable thereafter. As shown in FIGS. 4C and 4D, the end bolt 56 and bolt aperture 51 allow for some play and the end bolt 56 is also soft so it can flex. The flex under load means that the strut 50 is not firmly attached, so again, the neck 14 can vibrate. Returning to FIG. 4A, the end bolt 56 has a Teflon washer 57 and a metal washer 59 to allow it to slide up and down in the vertical slot 58. A fine adjustment screw 60 in the end block 52 is vertically disposed and abuts the end bolt 56. It extends through a threaded vertical aperture 61 in both the end block 52 and the back 46. A plate 62 is located on the strut 50 on an upper surface 64 and abuts the neck 14 at the neck distal end 66. The fine adjustment screw 60 allows the end bolt 56 to be moved up and down in the vertical slot 58. This embodiment, when used with embodiment C, as described below allows for adjustment of the neck up and down and in and out. It does not allow for adjustment of the neck in and out when used with embodiments A or B, except during construction of the guitar. The adjustment of the strut 50 and therefore the neck 14 can be done under string tension if embodiment 2 is used with embodiment C.

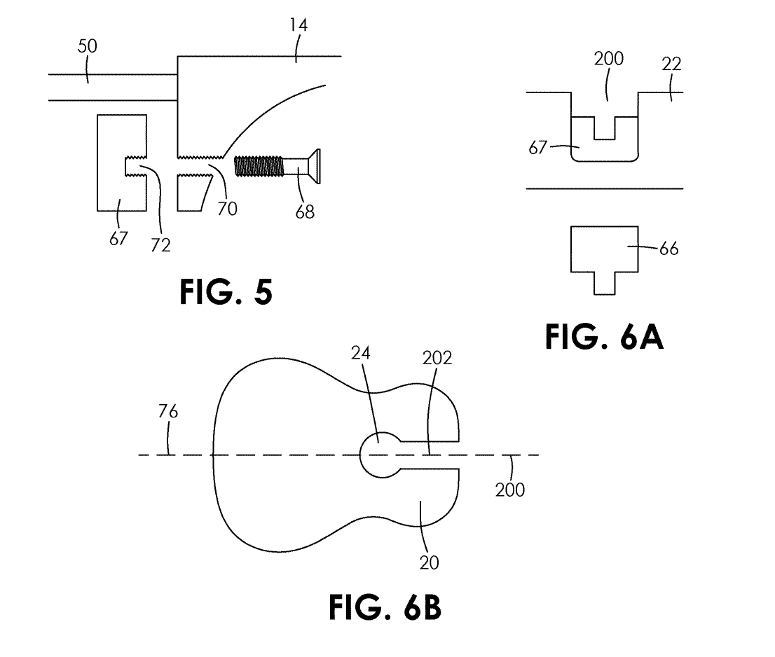

As shown in FIG. 5, the neck 14 is positioned on the neck block 67. In embodiment A, a strap pin 68 is used for positioning. The strap pin 68 is not threaded where it goes through the neck 14 in the neck strap pin aperture 70. The neck strap pin aperture 70 is also not threaded and is sized to allow for some movement of the strap pin 68. It is only threaded where it goes into the neck block 67, which has a threaded neck block strap pin aperture 72. This allows the neck 14 to be positioned up and down and in and out, while still allowing it to float relative to the soundbox 16, when constructed with the strut 50 that is adjustable in and out. It therefore can vibrate independently from the soundbox 16. The positioning of the neck 14 can be altered when the instrument is under string tension. As shown in FIG. 6A, the soundbox aperture 200 is the same profile as the distal end 66 of the neck 14. The neck 14 floats in the soundbox aperture 200. There is only one attachment point with the neck block 67 and that is the strap pin 68.

As shown in FIG. 6A, the soundbox aperture 200 is the same profile as the distal end 66 of the neck 14. It is for receiving the neck 14 and strut 50. These are assembled and introduced as a unit. The neck 14 and integral fretboard with frets 29 is accepted into the soundhole slot 202 (see FIG. 6B), which is an extension of the soundhole 24 in the soundboard 20 and is continuous with the soundbox aperture 200.

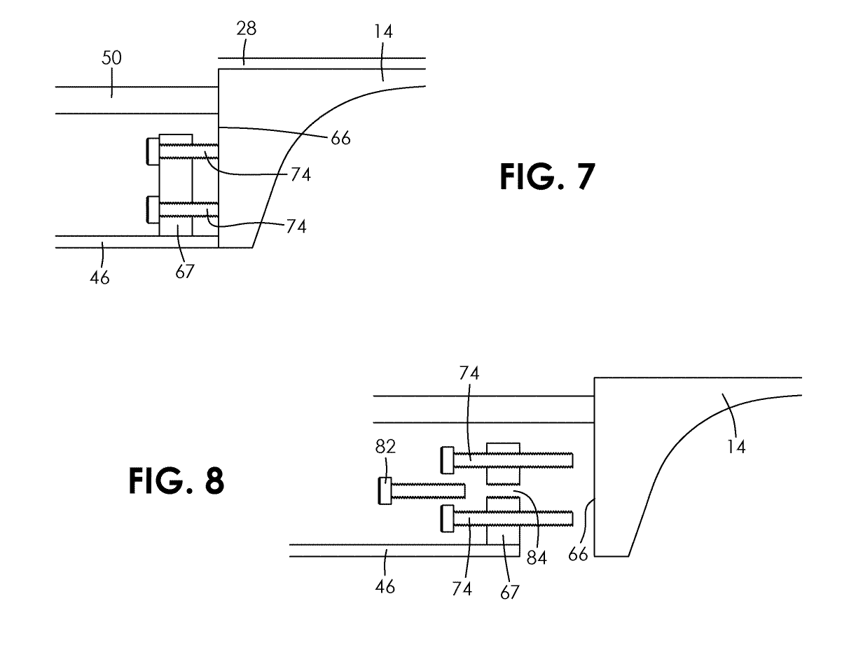

In another embodiment, embodiment B, shown in FIG. 7, there is no strap pin nor is there the strap pin aperture in the neck 14. Instead, a pair of intonation pins 74 position the neck 14 on the neck block 67. The intonation pins 74 may be threadedly attached to the distal end 66 of the neck 14 and abut the neck block 67, or, preferably, the neck block 67 may have the intonation pins 74 threadedly attached to it. In the latter case, the intonation pins 74 abut the distal end 66 of the neck 14. This allows the neck 14 to move in and out of the soundbox aperture 200, therefore allowing for intonation, when constructed with the strut 50 that is adjustable in and out (embodiment 1). This also allows the neck 14 to move up and down. Further, the neck 14 can be shifted from side to side relatively to the longitudinal axis 76 (see FIG. 6B). The intonation pins 74 therefore locate the neck 14 relative to the soundbox 16 and bridge 80. This allows for the string pull to be adjusted to be normal to the bridge 78, reducing torsional stress on the bridge 80 and soundboard. The neck 14 is floating freely from the soundbox 16 and both the neck 14 and soundbox 16 can vibrate independently. The positioning of the neck 14 can be altered when the instrument is under string tension. As shown in FIG. 6A, the soundbox aperture 200 is the same profile as the distal end 66 of the neck 14. The neck 14 floats in the soundbox aperture 200. There is no attachment point between the neck 14 and the neck block 67.

In another embodiment, embodiment C, shown in FIG. 8, there is no strap pin nor is there the strap pin aperture in the neck 14. Again, there are a pair of intonation pins 74 that position the neck 14 on the neck block 67. The intonation pins 74 may be threadedly attached to the distal end 66 of the neck 14 and abut the neck block 67, or, preferably, the neck block 67 may have the intonation pins 74 threadedly attached to it. In the latter case, the intonation pins 74 abut the distal end 66 of the neck 14. There is also an intonation bolt 82. The intonation bolt 82 is threaded and extends from the interior 83 of the soundbox 16 through a threaded intonation bolt aperture 84 in the neck block 67, through to the distal end 66 of the neck 14, where it abuts the distal end 66 of the neck 14. The intonation bolt 82 allows for positioning of the neck 14 in and out of the soundbox 16. This embodiment therefore does not require that the strut 50 be adjustable in and out, but it can be constructed with the adjustable strut 50. This embodiment also allows the neck 14 to move up and down. Further, the neck 14 can be shifted from side to side relatively to the longitudinal axis 86. This allows for the string pull to be adjusted to be normal to the bridge 80. The intonation pins 74 and the intonation bolt 82 therefore locate the neck 14 relative to the soundbox 16 and bridge 80. The neck 14 is floating freely from the soundbox 16 and both the neck 14 and soundbox 16 can vibrate independently. The positioning of the neck 14 can be altered when the instrument is under string tension. The neck 14 is urged out from the soundbox 16 by the intonation bolt 82 and back into the soundbox 16 by string tension. As shown in FIG. 6A, the soundbox aperture 200 is the same profile as the distal end 66 of the neck 14. The neck 14 floats in the soundbox aperture 200. neck 14 floats in the soundbox aperture 200. There is only one attachment point with the neck block 67 and that is the intonation bolt 82.

The guitar of the present technology can be assembled very quickly as follows:

### 1. Construction of the Body of the Guitar:

The soundboard and the back are attach the sides 22 to the soundboard 20 and back 46 of the guitar 10 with kerfing 100. Once glued, binding 100 is glued around the joint between the sides and each of the soundboard 20 and the back 46.

### 2. Introduction of the Strut:

The neck 14 and strut 50 are assembled into a unit or are provided as a unit body. The neck 14 and strut 50 are slid into the soundbox 16 of the guitar 10 as the unit, through the soundbox aperture 200. The strut 50 abuts the end block 52 located on the distal inner surface 42, and is adjustably affixed by an end bolt 56 or by the strap peg. The strut 50 is adjusted by adjusting both the end bolt 56 and the adjustment screw 62 in embodiment 1 and embodiment 2.

### 3. Stringing the Instrument:

The instrument is strung as one would normally string a guitar except that the alignment of the strings 28 is kept normal to the bridge 82 by the intonation pins 74, which allows the neck 14 to move from side to side as needed. As the intonation pins are fixed to one or the other, but not both of the neck block or the distal end of the neck, the neck is free to be moved from side to side. It is preferable that the intonation pins are threadedly attached to the neck block as this allows for access through the sound hole.

### 4. Intonating the Guitar:

The strung instrument can be intonated by adjusting neck length. This can be by threading the end bolt in or out, by threading the intonation bolt in or out or by adjusting both. The intonation bolt is accessed through the sound hole. The positioners (or locators), which are the strap pin or the intonation pins, are only fixed to one of the neck block or, in the case of the intonation pins, either the neck block or the distal end of the neck, but not both. The neck is free to float in the soundbox aperture and can therefore be urged in and out from the neck block.

### 5. Adjusting Action:

The strung instrument can have the action adjusted by altering the neck height. Adjusting the strut up and down effects this. The fine adjustment screw can be used to urge the bolt up in the embodiment in which the end bolt does not extend into the ambient atmosphere. String tension allows the end bolt to drop back down when not urged by the fine adjustment screw.

### 6. Tuning the Strings:

The strut 50 allows the soundbox 16 to be vibration free or essentially vibration free, because string contact and tension can be eliminated from the soundbox 16. A digital system such as, but not limited to Antares Auto-Tune® can be used to adjust and correct the pitch of each string. Such adjustment has not been useful for acoustic guitars, because of the soundbox vibration.

If the guitar 10 is adjusted to provide an essentially vibration free soundbox 16, the stationary voice coil with moving magnet 35 can be used to control movement of the soundboard 20.

The features of the present chordophone instrument impart superior sustain, resonance and volume to the instrument, and allow for intonation and action adjustment in the strung instrument, while reducing the stresses and strains on the soundboard. Torsional stress on the bridge is also reduced.

The foregoing is a description of an embodiment of the technology. As would be known to one skilled in the art, variations that do not alter the scope of the technology are contemplated. For example, the instrument may have more or less than six strings and need not be a guitar, but any instrument in the chordophone family, for example but not limited to a violin, a ukulele, lute or mandolin. The intonation bolt may be found in all the combinations of the embodiments.

1. A chordophone instrument, the chordophone instrument comprising: a soundbox, which defines an interior, the soundbox comprising sides with an upper edge and a lower edge, a back attached to the lower edge and a soundboard attached to the upper edge, the soundboard comprising a soundhole; an end block on an inner surface of the sides at a distal end of the instrument, the end block including a substantially vertically disposed slot; a bridge; a neck, the neck including a distal end and a proximal end, the neck in floating engagement with the soundbox; a strut, the strut extending from the end block to the distal end of the neck; an end bolt, the end bolt in threaded, adjustable engagement with a distal end of the strut and extending into the slot; a substantially vertically disposed fine adjustment screw, the fine adjustment screw abutting the end bolt, threadedly engaged in the end block, and extending through the back to an ambient environment; a headstock terminating the neck at the proximal end; at least one string extending between the headstock and the bridge; a neck block on an inner proximal surface of the sides; an intonation bolt, the intonation bolt in threaded engagement with the neck block and extending from the interior of the soundbox to the distal end of the neck, where it abuts the neck; and a neck positioner in threaded engagement with the neck block and in contact with the neck at the distal end.

2. The instrument of claim 1, wherein the instrument is a guitar.

3. The instrument of claim 2, wherein the neck positioner is either: a strap pin passing from the ambient environment through the neck, in an unthreaded oversized aperture, proximate the soundbox and in threaded engagement with the neck block; or a pair of intonation pins in threaded engagement with the neck block and abutting the distal end of the neck or vice versa.

4. The instrument of claim 3, wherein the sides at the distal end of the instrument include the substantially vertical slot and the end bolt extends through the slot to the ambient environment.

5. The instrument of claim 4, wherein the neck positioner is the strap pin.

6. The instrument of claim 3, wherein the neck positioner is the pair of intonation pins.

7. The instrument of claim 6, wherein the neck block defines a balance point for the neck and the strut, with the weight being equally distributed between the strut and the neck.

8. The instrument of claim 8, wherein the end bolt is a flexible bolt.

9. A method of constructing a chordophone instrument, the chordophone instrument comprising: a soundbox, the soundbox comprising sides, a back and a soundboard, the soundboard comprising a soundhole; an end block on an inner distal surface of the sides, the end block including a vertically disposed slot; a bridge; either a neck and a strut, or neck and strut unit body, the neck including a distal end and a proximal end; an end bolt; a fine adjustment screw; a headstock terminating the neck at the proximal end; a neck block at a proximal end of the soundbox; an intonation bolt; and a pair of intonation pins attached to either the neck block or a distal end of the neck, the method comprising:
attaching the back of the soundbox and the soundboard to the sides of the soundbox to provide the soundbox with a soundbox aperture and an interior; connecting the strut to the neck at a neck distal end or employing the or neck and strut unit body;
introducing the strut and the neck so connected together into the soundbox through the
soundbox aperture and allowing it to float therein;
adjustably affixing the strut to the end bolt, adjustably locating the end bolt in the slot in the end block;
adjustably affixing the fine adjustment screw in the end block and butting it against the end bolt;
threadedly engaging the intonation pins to either the distal end of the neck or the neck block but not both;
either abutting the intonation pins that are attached to the distal end of the neck against the neck block proximally or abutting the intonation pins that are attached to the distal end of the neck against the neck block proximally;
threadedly engaging the intonation bolt to the neck block and abutting it against the distal end of the neck;
and stringing the instrument, to provide a strung instrument.

10. The method of claim 9, further comprising adjusting the angle of the strings relative to the bridge by shifting the neck to one side or the other about the intonation pins.

11. The method of claim 10, further comprising intonating the strung instrument by urging the neck to or away from the neck block with the intonation bolt.

12. The method of claim 11, further comprising adjusting the neck angle of the strung instrument by moving the end bolt up or down in the vertically disposed slot.

13. The method of claim 12, wherein a vertically disposed fine adjustment screw urges the end bolt up in the vertically disposed slot.

14. A method of constructing a chordophone instrument comprising: a soundbox, the soundbox comprising sides, a back and a soundboard, the soundboard comprising a soundhole; an end block, an end block on an inner distal surface of the sides, the end block and the side both including a distally located vertical slot; a bridge; either a neck and a strut, or neck and strut unit body, the neck including a distal end and a proximal end; an end bolt; a headstock terminating the neck at the proximal end; a neck block at a proximal end of the soundbox; a pair of intonation pins threadedly attached to either the neck block or a distal end of the neck, the method comprising: and
attaching the back of the soundbox and the soundboard to the sides of the soundbox to provide the soundbox with a soundbox aperture and an interior; connecting the strut to the neck at a neck distal end or employing the or neck and strut unit body;
introducing the strut and the neck so connected together into the soundbox through the
soundbox aperture and allowing it to float therein;
adjustably affixing the strut to the end bolt, adjustably locating the end bolt in the slot in the end block and sides;
threadedly engaging the intonation pins to either the distal end of the neck or the neck block but not both;
either abutting the intonation pins that are attached to the distal end of the neck against the neck block proximally or abutting the intonation pins that are attached to the distal end of the neck against the neck block proximally;
and stringing the instrument, to provide a strung instrument.

15. The method of claim 14, further comprising adjusting the angle of the strings relative to the bridge by adjusting the intonation pins in or out relative to one another.

16. The method of claim 15, further comprising intonating the strung instrument by urging the neck to or away from the neck block with the end bolt and strut.

17. The method of claim 16, further comprising adjusting the neck angle of the strung instrument by moving the end bolt up or down in the vertically disposed slot.

18. A chordophone instrument, the chordophone instrument comprising: a soundbox, which defines an interior, the soundbox comprising sides with an upper edge and a lower edge, a back attached to the lower edge and a soundboard attached to the upper edge, the soundboard comprising a soundhole; an end block on an inner distal surface of the sides, the end block and the sides including a substantially vertically disposed slot; a bridge; a neck, the neck including a distal end and a proximal end, the neck in floating engagement with the soundbox; a strut, the strut extending from the end block to the distal end of the neck; an end bolt, the end bolt in threaded, adjustable engagement with a distal end of the strut and extending into the slot; a headstock terminating the neck at the proximal end; at least one string extending between the headstock and the bridge; a neck block on an inner proximal surface of the sides; an intonation bolt, the intonation bolt in threaded engagement with the neck block and extending from the interior of the soundbox to the distal end of the neck, where it abuts the neck; and a pair of intonation pins either in threaded engagement with the neck block and abutting the neck at the distal end or vice versa.

19. The instrument of claim 18, wherein the strut and neck are provided as a unit body.

20. The instrument of claim 18, further comprising an intonation bolt, the intonation bolt in threaded engagement with the neck block and extending from the interior through the neck block and abutting the distal end of the neck.
